(19) United States
(12) Patent Application Publication
(10) Pub. No.: US 2009/0037809 A1
(43) Pub. Date: Feb. 5, 2009

(54) SERVER BASED CONTROL OF AD PLACEMENT IN CLIENT SOFTWARE

(75) Inventors: Matthias Baer, Seattle, WA (US); Kollen Glynn, Newcastle, WA (US); Amy C. Nathanson, Seattle, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 12/057,374

(22) Filed: Mar. 28, 2008

Related U.S. Application Data
(60) Provisional application No. 60/953,455, filed on Aug. 1, 2007.

(51) Int. Cl. G06F 17/00

(52) U.S. Cl. 715/243

(57) ABSTRACT

A system and methods for server based control of ad placement in client software wherein a server controls the area in which advertisements appear in the client software application. A user interface associated with the client software area reclaims an area where the advertisement was displayed after the advertisement is disabled. Different types or classes of advertisements may be displayed within a single area in user interface of the application.

### CROSS-REFERENCE TO RELATED APPLICATIONS

This application claims benefit to U.S. Provisional Patent Application No. 60/953,455 (attorney docket number 321669.01), filed on Aug. 1, 2007.

### BACKGROUND

Internet advertising is typically seen in World Wide Web pages. It would be advantageous if network-connected client applications could also display advertising as part of the application's user interface.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples provide systems and methods for server based control of ad placement in client software. One aspect includes the server controlling the area in which advertisements appear in a client software application. Another aspect includes a user interface reclaiming an area where an advertisement was displayed after the advertisement is disabled. One other aspect includes showing different types of advertisements within a single area in user interface of the application. More particularly, the server determines the size of the advertisement to show within a predetermined location.

An aspect of the present examples includes defining “control groups” to provide different advertisement layouts to different groups of users for the purpose of testing and other scenarios. Another aspect includes securing the advertisement layout data on the client system. One other aspect includes server-side control of client user interface elements.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example of a computing device for implementing one or more embodiments of the invention.

FIG. 2 shows an example system for server based control of advertisement placement in client software.

FIG. 3 shows and example method for server based control of advertisement placement in client software.

FIG. 4 shows an example user interface including an advertisement in client software controlled by a server.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

Although the present examples are described and illustrated herein as being implemented in a system for server based control of advertisement placement in client software, the systems and methods described are provided as examples and not as limitations. As those skilled in the art will appreciate, the present examples are suitable for application in a variety of different types of server based control of advertisement placement in client software systems.

The inclusion of advertisements within the user interface of a networked client application may allow a developer of the client application to provide the client application for free or at reduced cost to a customer. The developer of the client application may also wish to develop a version of the same client application that does not include advertisements for customers that do not wish to use the version of the client application that includes advertisements. The developer of the client application may wish to maintain one code base between the free advertisement-funded version and the version that does not include advertisements.

The example system for server based control of advertisement placement in client applications systems provides functionality for the client application to periodically connect to a server and request an advertisement layout. Certain advertisement locations within the user interface of the client application can be remotely enabled or disabled by the server. The other user interface elements included in the client application move and/or change dimensions to occupy the free space formerly occupied by the advertisement such that users do not see that there an advertisement may appear in that area. The server may further enable or disable advertisements within a client application for groups of users, for example, a group of users associated with a company.

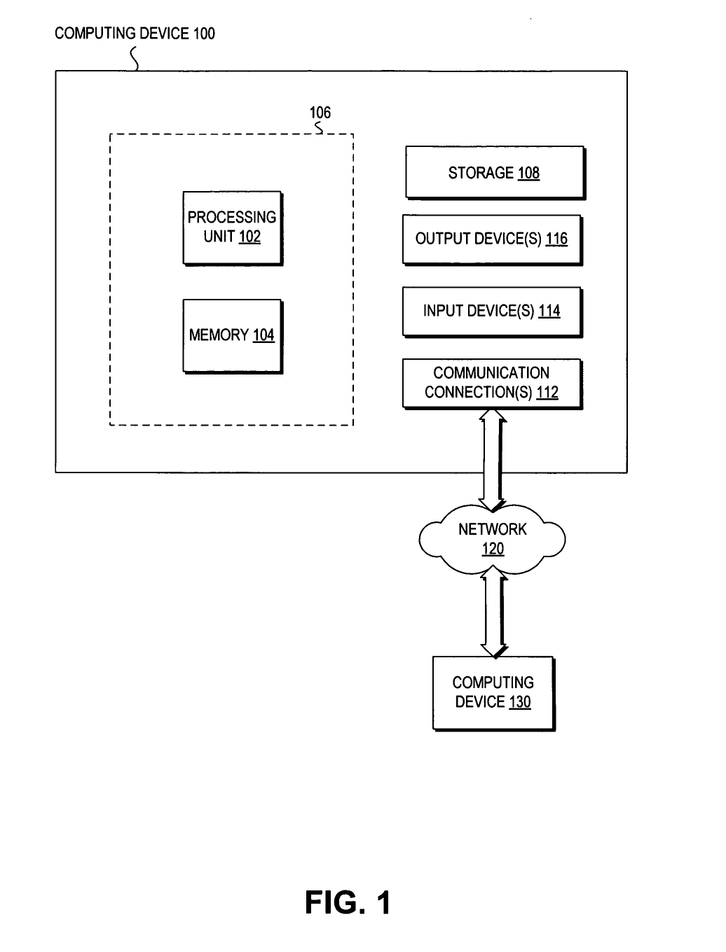

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 1 shows an example of a computing device 100 for implementing one or more embodiments of the invention. In one configuration, computing device 100 includes at least one processing unit 102 and memory 104. Depending on the exact configuration and type of computing device, memory 104 may be volatile (such as RAM), non-volatile (such as ROM, flash memory, etc.) or some combination of the two. This configuration is illustrated in FIG. 1 by dashed line 106.

In other embodiments, device 100 may include additional features and/or functionality. For example, device 100 may also include additional storage (e.g., removable and/or non-removable) including, but not limited to, magnetic storage, optical storage, and the like. Such additional storage is illustrated in FIG. 1 by storage 108. In one embodiment, computer readable instructions to implement embodiments of the invention may be stored in storage 108. Storage 108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 104 and storage 108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also include communication connection(s) 112 that allow device 100 to communicate with other devices. Communication connection(s) 112 may include, but is not limited to, a modem, a Network Interface Card (NIC), or other interfaces for connecting computing device 100 to other computing devices. Communication connection(s) 112 may include a wired connection or a wireless connection. Communication connection(s) 112 may transmit and/or receive communication media.

Communication media typically embodies computer readable instructions or other data in a “modulated data signal” such as a carrier wave or other transport mechanism and includes any information delivery media. The term “computer readable media” may include communication media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may include input device(s) 114 such as keyboard, mouse, pen, voice input device, touch input device, infra-red cameras, video input devices, and/or any other input device. Output device(s) 116 such as one or more displays, speakers, printers, and/or any other output device may also be included in device 100. Input device(s) 114 and output device(s) 116 may be connected to device 100 via a wired connection, wireless connection, or any combination thereof. In one embodiment, an input device or an output device from another computing device may be used as input device(s) 114 or output device(s) 116 for computing device 100.

Components of computing device 100 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 100 may be interconnected by a network. For example, memory 104 may be comprised of multiple physical memory units located in different physical locations interconnected by a network.

Those skilled in the art will realize that storage devices utilized to store computer readable instructions may be distributed across a network. For example, a computing device 130 accessible via network 120 may store computer readable instructions to implement one or more embodiments of the invention. Computing device 100 may access computing device 130 and download a part or all of the computer readable instructions for execution. Alternatively, computing device 100 may download pieces of the computer readable instructions, as needed, or some instructions may be executed at computing device 100 and some at computing device 130. Those skilled in the art will also realize that all or a portion of the computer readable instructions may be carried out by a dedicated circuit, such as a Digital Signal Processor (DSP), programmable logic array, and the like.

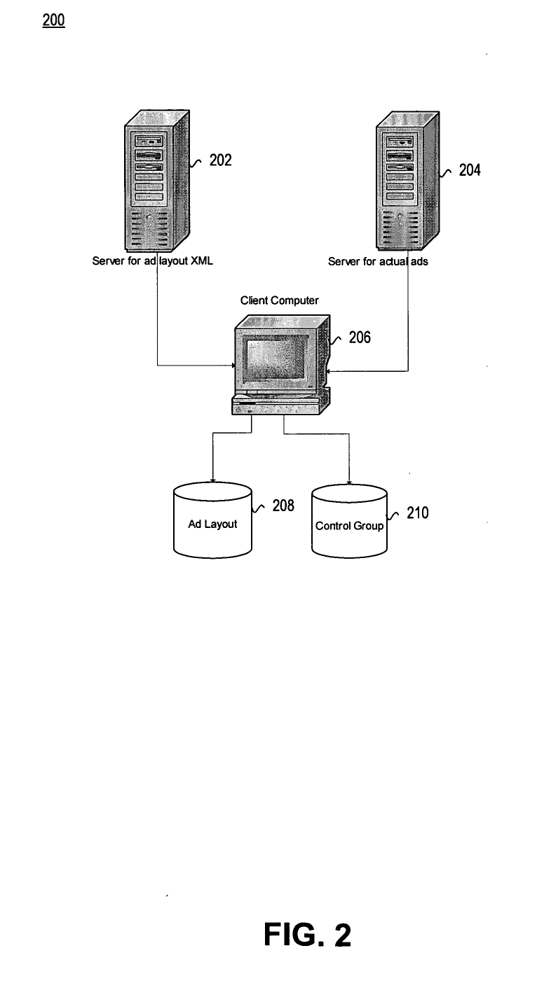

FIG. 2 shows an example system 200 for server based control of advertisement (“ad”) placement in client software. A client computer including a software application that may have an advertisement placed by a server 206 is communicatively coupled to a server for advertisement layout markup 202 and an advertisement server 204. The client computer 206 includes an advertisement layout data store 208 and a user interface control group data store 210. The terms “software application” and “client application” and the like as used herein refer to any software or the like configured to practice aspects of the present invention including, but not limited to, full software products, software modules, portions of applications, dynamic link libraries (DLLs) or the like, drivers, or any other form of computer-executable instructions or the like.

A client application included on the client computer 206 includes a pre-defined advertisement layout to be used if the client computer does not include an internet connection or has not yet connected to the server for advertisement layout markup. Such a default layout defines which of a predetermined set of areas in the user interface will display advertisements. If advertisements are enabled in a predetermined area of the user interface within which advertisements are allowed, advertisements will be displayed. In the case where advertisements are disabled within a predetermined area that typically allows the display of advertisements, advertisements will not display, and other user interface elements generally fill in the area where the advertisement would typically display.

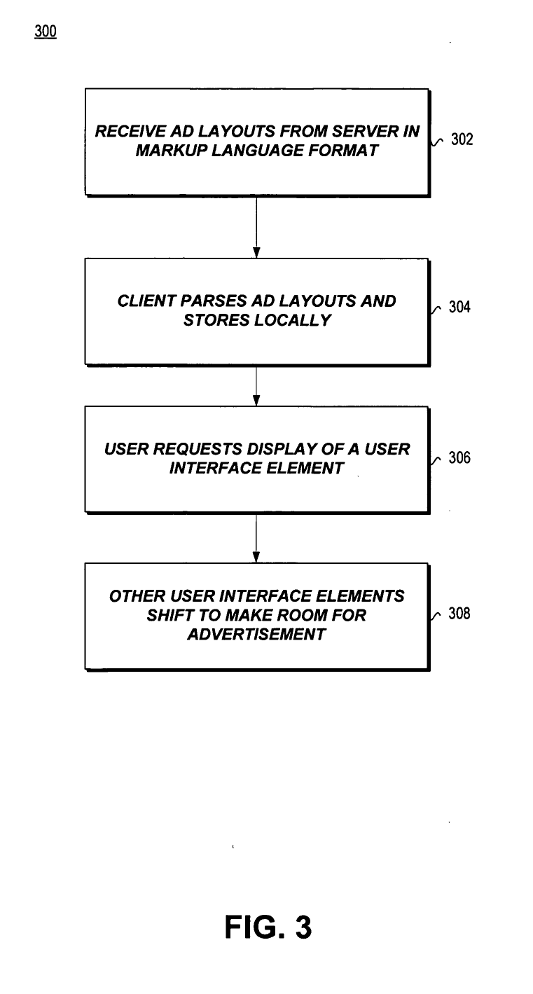

FIG. 3 shows and example method for server based control of advertisement placement in client software 300.

At block 302, advertisement layouts are received for both the ad-funded and the ad-free versions of the user interface in a markup language format such as the extensible markup language (XML). In an alternative embodiment, a message indicating a group or class may be sent to the server such that the server may respond with advertisement layouts for the group or class.

The markup language document typically includes a collection of data types that set the state for each area of the user interface. For example, the markup language document may include an array of bits representing the state for each area. The state may determine whether to show or hide advertisements at the bottom of all lists or more specifically show or hide advertisements at the bottom of a specific type of form, for example. The bits are intended to set the state of the user interface at any level using any criteria.

In an alternative example, control groups are specified in the markup language document received. Subsequent responses to the server may include information associated with the received control group information. In receiving such control group information, participation or inclusion in a control group may be specified.

At block 304, the advertisement layout and control group data is parsed and stored locally. In an alternative example, the advertisement layout data is encrypted. If at a later point it is detected that the advertisement layout data had been altered or tampered with through unauthorized means an appropriate action may be performed.

At block 306, a user requests display of a user interface element.

At block 308, a determination as to whether or not to display an advertisement. In the event that an advertisement user interface element is permitted to be shown, other user interface elements move and/or reposition to make room and the advertisement is displayed. In the event that an advertisement user interface element is not permitted to be displayed, the standard advertisement-free user interface layout is used.

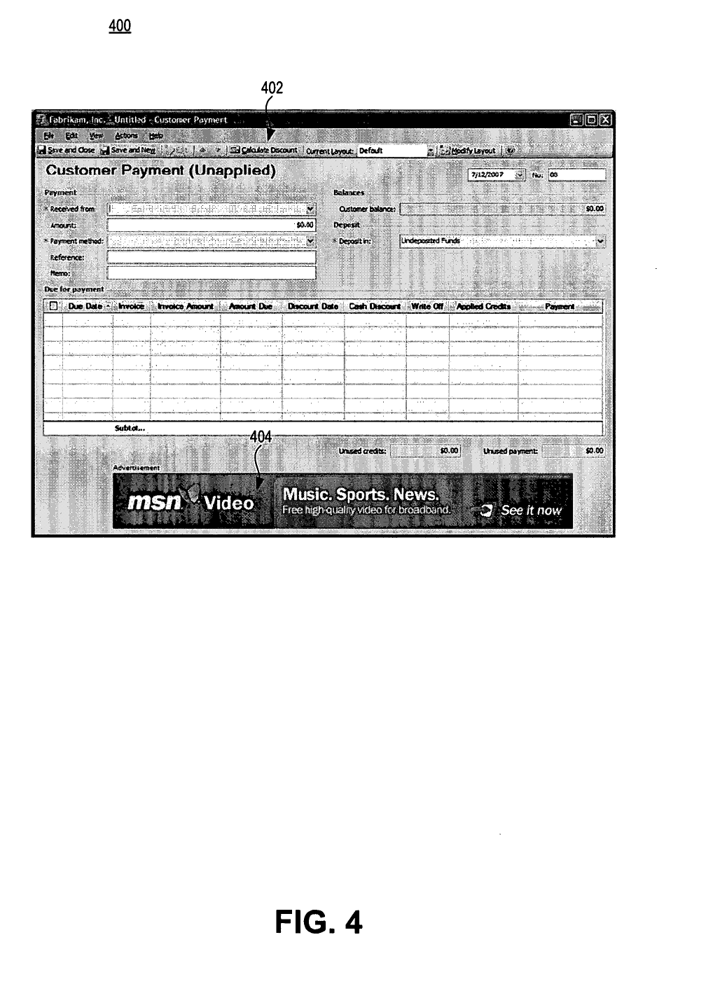

FIG. 4 shows an example user interface 400 including an advertisement 404 in client software controlled by a server. The user interface 400 includes a set of standard user interface elements 402 and an advertisement user interface element 404. The set of standard user interface elements 402 may move and/or reposition in response to the display of the advertisement user interface element 404 or the hiding of the advertisement user interface element 404.

1. A system for control of an advertisement in a user interface, the system comprising:
a client application operating on a client computer and coupled to an advertisement server and a layout server, wherein the user interface is associated with the client application; and
a layout data store associated with the client application and operating as part of the client computer,
wherein the client computer receives the advertisement from the advertisement server and a corresponding advertisement layout from the layout server, and wherein the client application shifts elements of the user interface responsive to the advertisement layout and displays the advertisement in the user interface in accordance with the advertisement layout.

2. The system of claim 1 wherein the advertisement layout is stored in the layout data store.

3. The system of claim 1 further comprising a predefined advertisement layout associated with the advertisement and included with the client application.

4. The system of claim 3 wherein if no advertisement layout is received then the predefined advertisement layout is used for the shifting and the displaying.

5. The system of claim 1 wherein if the advertisement is disabled then the shifting and the displaying do not occur.

6. The system of claim 1 wherein the advertisement layout is provided in an extensible markup language (“XML”) format.

7. The system of claim 1 further comprising:
a control group data store associated with the client application and operating as part of the client computer; and
control group information included in the advertisement layout and wherein the control group information is stored in the control group data store.

8. The system of claim 8 wherein the control group information is used to determine if the shifting and the displaying are performed.

9. A method for controlling an advertisement in a user interface, the method comprising:
receiving an advertisement layout from a layout server;
storing the advertisement layout;
determining if the advertisement should be displayed, wherein the advertisement is associated with the advertisement layout; and
if the advertisement should be displayed, then shifting elements of the user interface responsive to the advertisement layout and displaying the advertisement in the user interface in accordance with the advertisement layout.

10. The method of claim 9 wherein if no advertisement layout is received then a predefined advertisement layout is used for the shifting and the displaying.

11. The method of claim 9 wherein if the advertisement is disabled then the shifting and the displaying do not occur.

12. The method of claim 9 wherein the advertisement layout is provided in an extensible markup language (“XML”) format.

13. The method of claim 9 further comprising receiving control group information with the advertisement layout.

14. The method of claim 13 wherein the control group information is used to determine if the shifting and the displaying are performed.

15. A computer storage medium comprising computer-executable instructions that embody a method for controlling an advertisement in a user interface, the method comprising:
receiving an advertisement layout from a layout server;
storing the advertisement layout;
determining if an advertisement should be displayed, wherein the advertisement is associated with the advertisement layout; and
if the advertisement should be displayed, then shifting elements of the user interface responsive to the advertisement layout and displaying the advertisement in the user interface in accordance with the advertisement layout.

16. The computer storage medium of claim 15 further comprising receiving control group information with the advertisement layout.

17. The computer storage medium of claim 16 wherein the control group information is used to determine if the shifting and the displaying are performed.

18. The computer storage medium of claim 15 wherein if no advertisement layout is received then a predefined advertisement layout is used for the shifting and the displaying.

19. The computer storage medium of claim 15 wherein if the advertisement is disabled then the shifting and the displaying do not occur.

20. The computer storage medium of claim 15 wherein the advertisement layout is provided in an extensible markup language (“XML”) format.
